(19) United States
(12) Patent Application Publication
(10) Pub. No.: US 2011/0294390 A1
(43) Pub. Date: Dec. 1, 2011

(54) Interlocking Panel and Kit of Such Panels

(75) Inventors: Vincent Michalk, Montreal (CA); Robert Katz, Montreal (CA); Marc Bacon, Kanata-Sittsville (CA); Sylvain Duchene, Bromont (CA)

(73) Assignee: BRIK A BLOK TOYS INC., Montreal (CA)

(21) Appl. No.: 13/010,489

(22) Filed: Jan. 20, 2011

Related U.S. Application Data
(63) Continuation of application No. 12/469,189, filed on May 20, 2009.
Application No. 12/469,189 is a continuation of application No. PCT/CA2007/002098, filed on Nov. 20, 2007.
(60) Provisional application No. 60/859,993, filed on Nov. 20, 2006.

(51) Int. Cl. A63H 33/00; B23P 19/00

(52) U.S. Cl. 446/111; 29/700

(57) ABSTRACT

A modular system for forming without tools a variety of 3-dimensional structures comprises panels (10), and connectors (13, 14), and locking bridging members (30) for assembling the panels (10) together in a desired configuration. The panels can be disconnected so that the erected structure can be disassembled with ease for future reuse. The system can be used to erect children's playhouses made of polymer materials, as well as in a large variety of other applications to create 3-dimensional objects requiring rapid positive construction without tools.

### CROSS REFERENCE TO RELATED APPLICATIONS

This application is a Continuation Application of PCT Application No. PCT/CA2007/002098, filed on Nov. 20, 2007, which claims priority on U.S. Provisional Application No. 60/859,993, filed on Nov. 20, 2006, which is herein incorporated by reference.

### FIELD OF THE INVENTION

The present invention generally relates to an interlocking panel. More specifically, the present invention is concerned with a panel, in a panel building set, which can be locked and unlocked to another like panel.

### BACKGROUND OF THE INVENTION

Construction toys for children are commonly available and are comprised typically of 3-dimensional blocks having a brick-like appearance. Some such toys provide for interlocking between blocks, but due to their ungainly nature and/or small size, they cannot be made to enclose three-dimensional habitable spaces easily. Small interlocking blocks have been used to design and construct toys and shapes according to children's imagination, but these blocks are too small to create space enclosures cheaply or simply. For the same reason, these blocks cannot be used to create labyrinths, furniture, or other playthings at a scale which the child can play in.

Space enclosures specifically designed for play use as children's toys are typically not designed for flexibility as a system that can produce enclosures of many shapes, but rather are typically designed for a single end use, are shipped disassembled to save space, and are erected at the end use location. As such, they provide less incentive for creative play than if they were able to be joined together easily to make space enclosures according to the imagination of the end user. Assembly methods of such space enclosures can vary from using tools to using hook and loop interlocking fabric (Velcro™) as in U.S. Pat. No. 4,964,249 or more complex assembly means, such as U.S. Pat. No. 5,544,870. The simpler assembly methods are generally used for single-purpose structures, while the more complex assembly methods do not lend themselves to simple assembly and disassembly by children.

Use of foam blocks to make children's toy space enclosures is limited by cost, the need for space to store them, safety concerns related to flammability and hygiene, and the need to balance structural strength with compressibility, amongst other limitations.

This present invention allows children to rapidly create safe 3-dimensional structures in a wide variety of shapes, including space enclosures, and to disassemble them and store the parts in a very small space. The design allows manufacturing them and distributing them at a relatively low cost, thus creating a new class of children's toy.

### SUMMARY OF THE INVENTION

It is therefore an object of the present invention to provide a system for joining modular panels without tools to form 3-dimensional structures and to disassemble them for future reuse. The panels can mate mechanically with one another, and may be made of multiple geometric shapes of three or more sides, allowing them to form an almost infinite number of forms when joined together in various ways.

An aspect of the present invention is that assembly and disassembly of the panels is very easy and positive, so that panels sized for children's toys can easily be assembled by a child without the aid of an adult.

It is further an object of the present invention to provide panels that are designed to be stackable for storage, and may be made in sections and materials optimized for structural strength, stiffness, light weight or other desirable mechanical properties in order to ensure fitness for use.

Another object of this invention is to provide a fastening system allowing the positive assembly of panels at varying predetermined angles to each other in three dimensions, as well as the assembly of multiple panels emanating out of a common singular axis.

In order to allow the builder to plan for and visualize the intended structure, a further aspect of this invention is an interactive web-based tool which allows the builder to build a virtual representation of the structure by selecting from a library of parts and assembling them on a computer. In its basic form, this tool would allow, for example, children to construct virtual space enclosures and other toys and would allow them to print construction plans for their creation. This software could as well allow the ordering of the pieces required to build the designed forms. In addition to having an interactive web based tool, it is an object of this invention to provide software that could be loaded onto a computer to provide a means of designing and building forms with the library of parts all in a virtual environment.

According to the present invention, there is provided a system for joining panels to form 3-dimensional structures of a variety of shapes, comprising interlocking panels, connectors, and locking clips, wherein each panel has at least one connector on at least one of its edges, with said connector being adapted to provide a positive snap-in lock with a mating connector on an adjacent panel, such that the completed connection is able to swivel about a longitudinal axis of the connector to permit orienting the panels to a selected angle in relation to each other, and wherein adjacent parts of the panels may be fixed in place by one or more clips inserted along adjoining edges thereof to substantially prevent a rotation of the connectors.

More specifically, in accordance with the present invention, there is provided a panel comprising: at least first and second edges; cooperating first and second connection elements provided on the first and second edges, respectively; the first and second connection elements of adjacent panels being adapted to snap connect together to interlock the adjacent panels while allowing for a relative pivot between the adjacent panels.

More specifically, in accordance with the present invention, there is provided a kit for erecting 3-dimensional structures of a variety of shapes, comprising interlocking panels, connectors, and locking clips, wherein each panel has at least one connector on at least one of its edges, with said connector being adapted to provide a positive snap-in lock with a mating connector on an adjacent panel, such that the completed connection is able to swivel about a longitudinal axis of the connector to permit orienting the panels to a selected angle in relation to each other, and wherein adjacent parts of the panels may be fixed in place by one or more clips inserted along adjoining edges thereof to substantially prevent a rotation of the connectors.

The foregoing and other objects, advantages and features of the present invention will become more apparent upon reading of the following non-restrictive description of an illustrative embodiment thereof, given by way of example only, with reference to the accompanying drawings.

### BRIEF DESCRIPTION OF THE DRAWINGS

In the appended drawings:

FIG. 1 is a perspective view of a panel according to a non-restrictive illustrative embodiment of the present invention;

FIG. 2 is a vertical cross-sectional view of the panel of FIG. 1;

FIG. 3 is a fragmentary view of two panels similar to the panel of FIG. 1, illustrating a pair of C-shaped members and a pair of corresponding bars, in an unlocked position thereof;

FIG. 4A is a front view of two panels, similar to the panel of FIG. 1, assembled together in a locked position;

FIG. 4B is a schematic cross-sectional view taken along line A-A of FIG. 4A, showing the panels in the unlocked position;

FIG. 4C is a cross-sectional view taken along line A-A of FIG. 4A, now showing the panels coplanar in a locked position;

FIGS. 5A and 5B are cross-sectional views similar to FIG. 4C, but showing the two panels at various angles one with respect to the other;

FIG. 6A is a perspective view of a bridging member, according to an illustrative embodiment of the present invention;

FIG. 6B is a top plan view of the bridging member of FIG. 6A;

FIG. 7A is another fragmentary perspective view of the bridging element of FIG. 6A;

FIG. 7B is a cross-sectional view taken along the line B-B of FIG. 4A, showing the bridging member of FIG. 6A engaged to two adjacent panels of FIG. 1;

FIG. 8 is a fragmentary enlarged view of a corner of the panel of FIG. 1, illustrating a raised rib configuration;

FIG. 9A is a perspective view illustrating the bridging member of FIG. 6A before being inserted into two raised rib configurations of two panels of FIG. 1;

FIG. 9B is a view similar to FIG. 9A but showing the bridging member after having been engaged to the two raised rib configurations of two panels;

FIG. 10 is a front elevational view of a flat wall made from four interlocked panels of FIG. 1;

FIG. 11 is a perspective view of a variant of the interlocking system of FIG. 3, that is male and female connector elements herein shown in an unlocked position thereof, according to an illustrative embodiment of the present invention;

FIG. 12A illustrates the male and female connector elements of FIG. 11, just before being engaged together;

FIG. 12B illustrates the male and female connector elements of FIG. 11, engaged to one another;

FIG. 13A is a fragmented front elevational view of a female connecting element and a male connecting element, the latter having flanges on which are mounted center guiding posts protruding outwardly therefrom, according to a further illustrative embodiment of the present invention;

FIG. 13B is a schematic representation of an assembly of four panels being interlocked about a same axis; and

FIG. 13C is a cross sectional view of FIG. 13B.

### DETAILED DESCRIPTION OF THE INVENTION

The present invention relates to panels that can be connected by means of a snap-on connection so as to form various shapes and structures, including 3-dimensional structures. The panels can be manually assembled and disassembled. The panels can be provided, for example, with joiner parts, lockable hinge-type mechanisms and bridging elements.

A panel for use in a panel building set, according to non-restrictive illustrative embodiments of the present invention, will now be described. In a first embodiment, the panel comprises C-shaped female and bar male connection elements to allow two adjacent panels to be engaged together. In a second embodiment, the panel comprises further male and female connection elements, the panel of the second embodiment being otherwise similar to the panel of the first embodiment.

It is to be noted that the illustrative embodiments each feature a panel having four equal sides or edges; however, it is understood that the panels may have three edges or more, which may be of equal or different lengths.

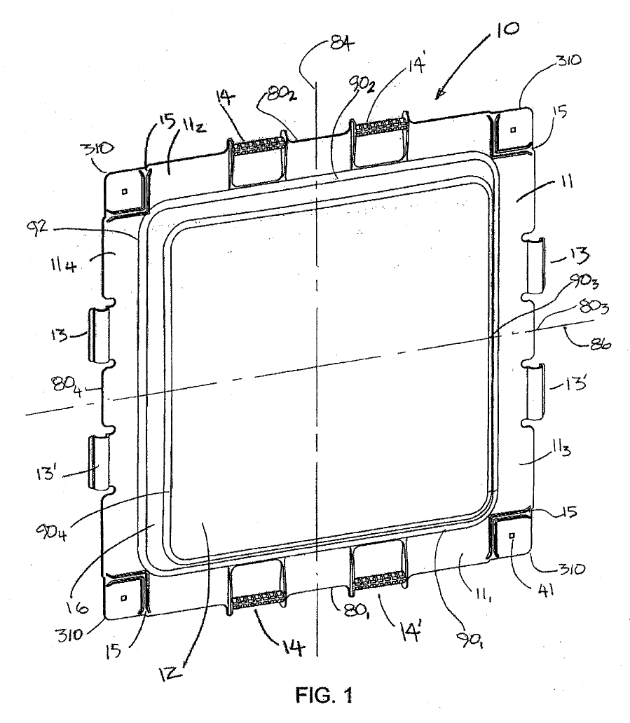

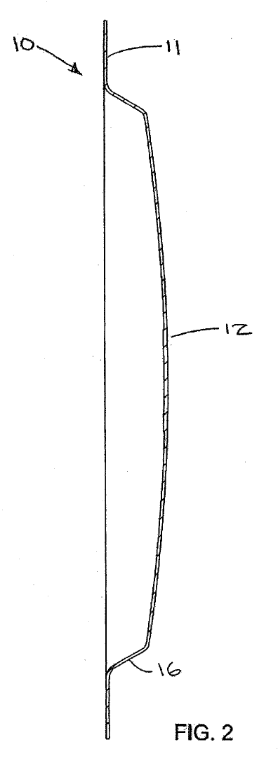

Referring now to FIGS. 1 and 2, a panel 10 is described. The panel 10 generally has the form of a square having four edges 80₁, 80₂, 80₃ and 80₄ of equal length. Panel 10 comprises a concentric, central square portion 12, the edges 90₁, 90₂, 90₃ and 90₄ of which are parallel to the edges 80₁, 80₂, 80₃ and 80₄ of panel 10. Central square portion 12 is slightly convex, as can be seen in FIG. 2. A square frame 16, having an external boundary 92, is formed on the edges 90₁, 90₂, 90₃ and 90₄ of the central square portion 12. A relatively flat perimeter flange or band 11 is formed on the external boundary 92 of the square frame 16, the perimeter band 11 being generally parallel to the central square portion 12. A raised rib configuration 15, which will be described in detail hereinbelow, is provided on each of the four corners 310 of the perimeter band 11.

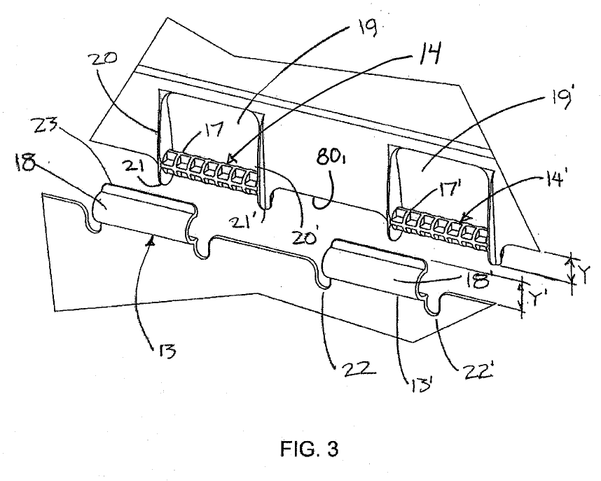

The perimeter band 11 comprises four sides 11₁, 11₂, 11₃, 11₄. The opposed sides 11₁ and 11₂ each comprise a pair of first snap-on connection elements 14 and 14′; likewise, the opposed sides 11₃ and 11₄ each comprise a pair of second snap-on connection elements 13 and 13′, which are configured to mate with a corresponding pair of the first snap on connection elements 14 and 14′ of another panel 10. Openings 19 and 19′ (see FIG. 3) are defined in the perimeter band 11 about respectively each of the first snap-on connection elements 14 and 14′, on both sides 11 and 11₂.

Still referring to FIG. 3, the first snap-on connection elements 14 and 14′ and the second snap-on connection elements 13 and 13′ will be described in more detail.

As previously mentioned, side 11₁ comprises two openings 19 and 19′, which are square-shaped and defined on one side by the square frame 16, and on the opposite side, by bars 17 and 17′ of first snap-on connection elements 14 and 14′, such that the longitudinal axes of bars 17 and 17′ are coaxial with the edge 80₁ of panel 10. Two protruding blades 21 and 21′ project from respectively each end of the bars 17 and 17′, perpendicular to the axes of the bars 17 and 17′ and generally parallel to the perimeter band 11.

Side 11₂ is similar to side 11₁; accordingly, a description of the former is similar to the above description of the latter.

Side 11₃ comprises a pair of second snap-on connection elements 13 and 13′ mounted on the edge 80₃ of panel 10. The second snap-on connection elements 13 and 13′ comprise respectively C-shaped members 18 and 18′ and finger tabs 23 and 23′. C-shaped members 18 and 18′ generally each have the form of a cylinder cut longitudinally just over its half-way point and are made of a resilient material and provide the snap-on connection to the bars 17 and 17′ of the connection elements 14 and 14′. Finger tabs 23 and 23′ are provided at free ends of the C-shaped members 18 and 18′, extend longitudinally therealong and protrude therefrom. C-shaped members 18 and 18′ are configured to accommodate respectively bars 17 and 17′ of another panel 10. Two slots 22 and 22′ are formed on edge 80₃, respectively at each end of second snap-on connection elements 13 and 13′. Typically, the bars 17 and 17′ are substantially of the same length as the second snap-on connection elements 13 and 13′.

Side 11₃ is similar to side 11₄; accordingly, a description of the former is similar to the above description of the latter.

The pair of first snap-on connection elements 14 and 14′ and the pair of second snap-on connection elements 13 and 13′ are respectively positioned congruently on edges 80₁ or 80₂, and on edges 80₃ or 80₄, so that in a locked position, the pair of first snap-on connection elements 14 and 14′ of one panel 10 is opposite to the pair of second snap-on connection elements 13 and 13′ of another panel 10. Likewise, slots 22 and 22′ are located respectively opposite to protruding blades 21 and 21′.

It is to be noted that the pair of first snap-on connection elements 14 and 14′ and the pair of second snap-on connection elements 13 and 13′ are, in the present embodiment, symmetrical about center lines 84 and 86 of panel 10.

In the locked position of two adjacent panels 10, C-shaped members 18 and 18′ of one panel 10 snap on bars 17 and 17′ of the other panel 10, such that the axes of the former are coaxial with the axes of the latter. In this manner, C-shaped members 18 and 18′ and bars 17 and 17′ form a pivot assembly about which the two panels 10 can pivot relative to one another. Slots 22 and 22′ ensure that protruding blades 21 and 21′ are not obstructed while a pivotal movement is effected between both panels 10.

Bars 17 and 17′ are bordered by structural ribs 20 and 20′, which merge into the protruding blades 21 and 21′. These elements will be described in more detail hereinbelow. Structural ribs 20 and 20′ have a function of locating and stabilizing bars 17 and 17′. The distance between structural ribs 20 and 20′ are such that the bars 17 and 17′ can be snapped into place in the second snap-on connection elements 13 and 13′ with little or no lateral play, while allowing the second snap-on connection elements 13 and 13′ to generally rotate freely about bars 17 and 17′. Openings 19 an 19′ allow a user's fingers to have access to bars 17 and 17′ and C-shaped members 18 and 18′. It should be noted that openings 19 and 19′ allow access to perform this function from both sides of panel 10. Accordingly, assembling or disassembling a structure made of panels 10 can be performed from both sides thereof.

Finger tabs 23 and 23′ of the second snap-on connection elements 13 and 13′, as shown in FIG. 3, can provide a gripping means so as to unsnap C-shaped members 18 or 18′ of one panel 10 from bars 17 or 17′ of another panel 10. Protruding blades 21 and 21′ protrude from perimeter edges 80₁ or 80₂ of panel 10 at a distance Y. Similarly, finger tabs 23 and 23′ protrude from perimeter edges 80₃ or 80₄ of panel 10, at a distance Y′, wherein Y=Y′, as shown in FIG. 3. In this manner, many panels 10 can be assemble in a symmetric fashion. It should be further noted that when multiple panels 10 are assembled together, for instance in a vertical fashion perpendicular to a support surface such as a floor, the lowermost row of panel perimeter edges 80 will be supported at a same elevation with respect to the floor since the panels are supported by the finger tabs 23/23′ or the protruding blades 21/21′ and since Y=Y′.

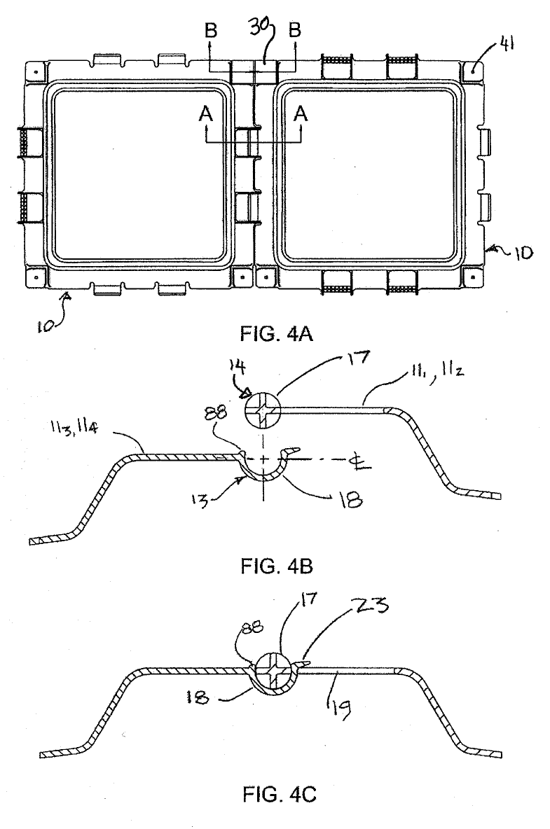

FIG. 4A illustrate two panels in a locked position, whereas FIGS. 4B and 4C are two sectional views therefrom, respectively in an unlocked position and in a locked position. Turning now to FIG. 4B, C-shaped element 18 is characterized by a slightly closed “C” shape, i.e. a transversal view of C-shaped element 18 is characterized by a perimeter which is slightly longer than that of exactly half a circle, the C-shaped element 18 extending at 88, i.e. on a side thereof opposite the finger tab 23, beyond a median plane of the perimeter band/flange 11. The slightly closed configuration of the “C” provides interference for the entry of bars 17 and 17′. The material and thickness used to manufacture C-shaped member 18 and 18′ are chosen so as to allow limited outward deflection thereof, and the deflection is to be resilient. The material can be advantageously a polymer resin. Accordingly, the interference between C-shaped member 18 and bar 17 is overcome by a resilient deformation of C-shaped member 18. FIG. 4C illustrates a bar 17 in a locked position in a C-shaped element 18, wherein the latter accommodates and retain therein the former.

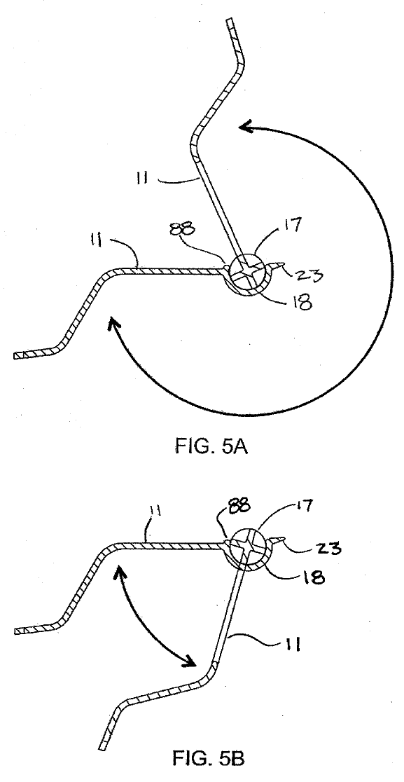

Referring to FIGS. 5A and 5B, the two panels 10, which are in a locked position, can pivot relative to one another by an angle greater than 270°, the pivotal movement being only restricted by the perimeter band 11 of a first panel's abutting against bulge 88 of another panel 10, wherein the extended span of the pivot angle advantageously favors both a flexibility of construction and an increased number of configurations.

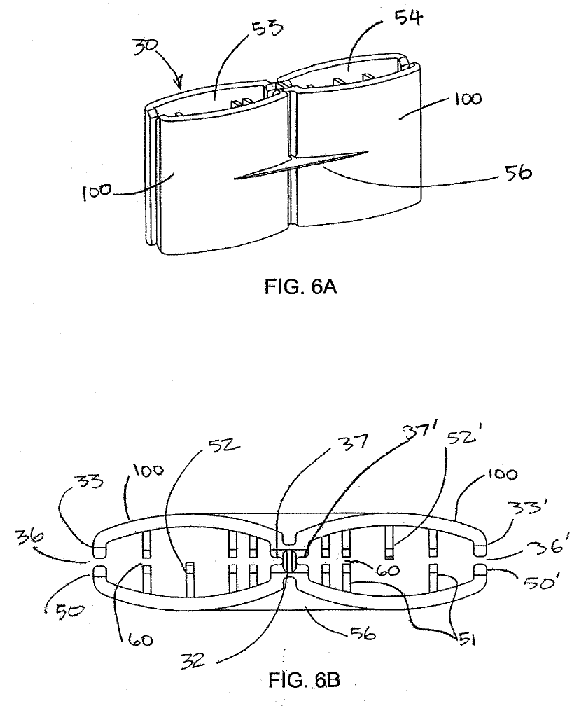

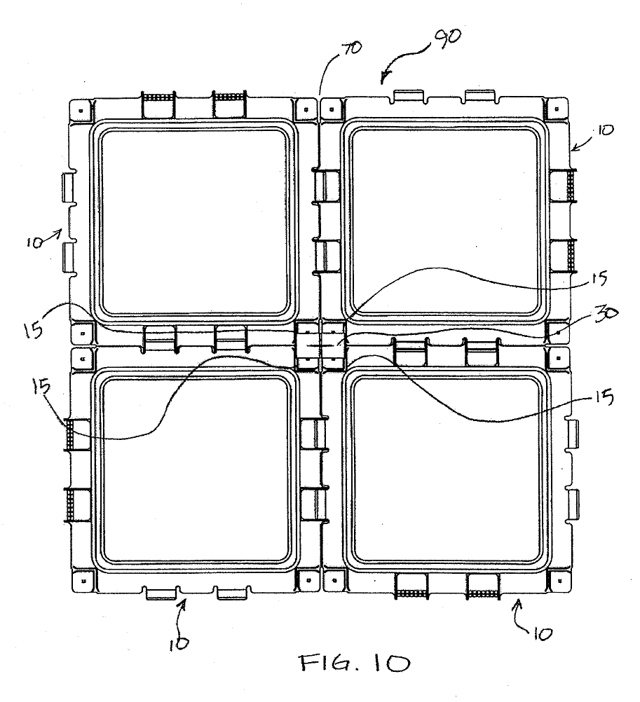

It is possible to assemble many panels 10, as shown in FIG. 10, so as to form a flat wall 90. In order to stabilize the wall 90, a bridging member 30 in the form of a locking clip, as better shown in FIGS. 6A and 6B, is provided. Bridging member 30 is inserted between adjacent panels both for bridging the panels 10 and for stabilizing them at a chosen angle as desired by the builder. More specifically, bridging member 30 allows stabilizing two panels together from an acute angle to an angle of 180° therebetween, depending on the angle chosen for the bridging member 30. Equally the bridging member can be made to have variable angles by way of, for example, a lockable hinge type mechanism, or a multiple bridging elements creating a center spoke type bridge system.

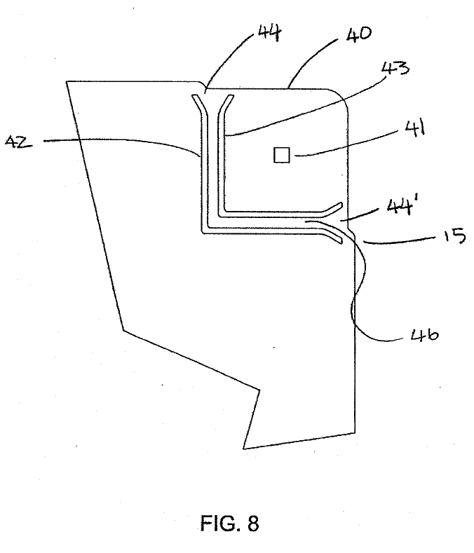

Referring now to FIGS. 1 and 8, about each corner 310 of the panel 10, there is provided on each side of the panel 10 a rib configuration 15, which is generally characterized by two parallel and spaced “L”-shaped ribs 42 and 43. In the present illustrative embodiment, each segment of the “L” is perpendicular to an edge of panel 10. However, it is believed to be within the reach of one skilled in the art to envisage other configurations for a rib configuration, depending on the geometry of a panel. At each end, the “L”-shaped ribs 42 and 43 open or flare (in a Y-shape) to form funnels 44 and 44′, so as to facilitate an insertion of the bridging member 30 in a gap 46 defined between the “L”-shaped ribs 42 and 43. More particularly, facing, inwardly extending, end walls (or hooks) 33 and 33′ as well as 50 and 50′ of the bridging member 30 can register snugly in the gaps 46 of rib configurations 15 provided on adjacent corners of the two connected panels 10 and on each side of these panels 10.

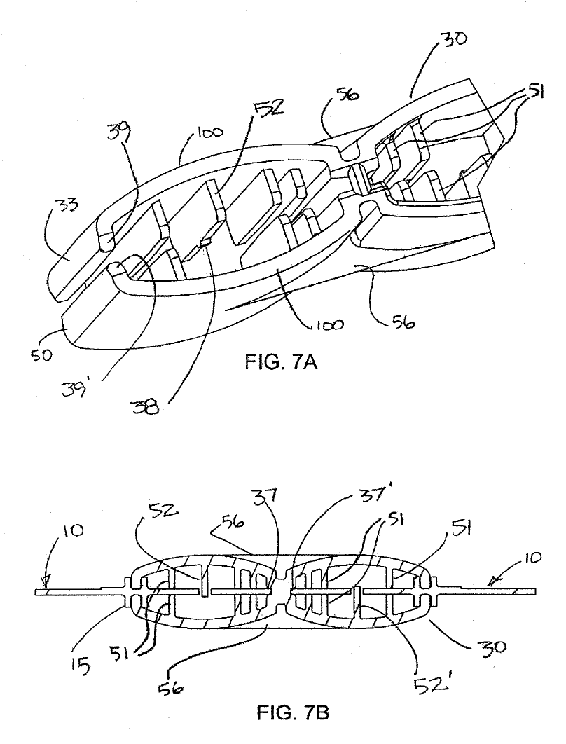

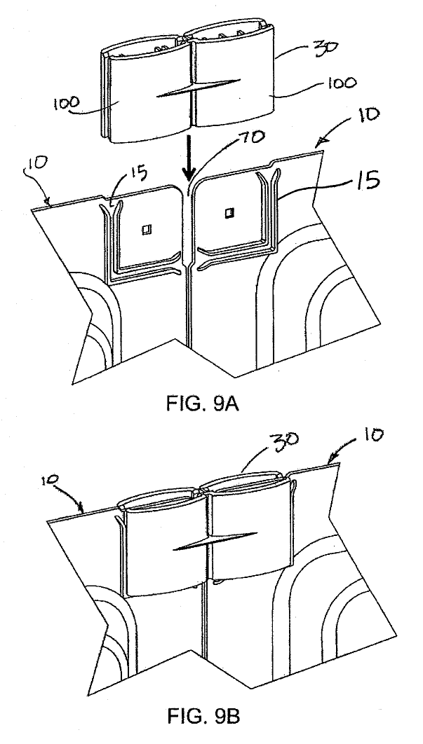

Referring now to FIGS. 6A, 6B, 7A and FIG. 7B, the bridging member 30 will now be described in detail. Bridging member 30 has a general configuration of two back-to-back elongated “C” shapes 100 linked by a separating wall 32, the thickness of which is substantially equal to a gap 70 between two joined panels 10, and as shown in FIG. 9A. Opposite to the separating wall 32, the “C” shapes 100 each terminate with a hook-like end wall 33 and 50. As seen in FIG. 1, the panel 10 is characterized by slightly raised rib configurations 15 on all of its corners. Two slot openings 36 and 36′ are defined at both ends of bridging member 30 and define the open ends of the “C” shapes 100. Typically, the width of the slot openings 36 and 36′ is generally the same as, or slightly less than, the thickness of perimeter band 11, so that when bridging member 30 is in place, it provides a positive squeezing on perimeter band 11 of panel 10 by way of resilient deformations of the elongated “C” shapes 100 of bridging member 30. Advantageously, bridging member 30 is made of a slightly flexible polymer material having a spring-like memory.

Inside the elongated “C” shapes 100, and opposite to slot openings 36 and 36′, two corresponding slots or grooves 37 and 37′ are defined in the separating wall 32. Similarly, the thickness of slots 37 and 37′ is generally the same as, or slightly less than, the thickness or perimeter band 11. For the purposes of rendering an example in this invention the bridging member 30 is symmetrical about the center of the separating wall 32. As seen in FIG. 7A, hook-like end walls 33 and 50 have chamfered corners 39 and 39′ so as to facilitate locating the bridging member 30 on the rib configurations 15. Once inserted in the rib configurations 15, the bridging member 30 allows for stabilizing two interlocked panels 10 at a chosen angle. The bridging member 30 can further comprise rigidifying ribs 56. In the present illustrative embodiment, the two elongated “C” shapes 100 are so configured as to bridge two panels 10 at an angle of 180°. However, different bridging elements can be used, such that the “C” shapes thereof are so configured as to bridge two panels at another angle, for angle.

Referring now to FIG. 9A, the bridging member 30 is used to stabilize two adjoining panels 10 that are already connected via the first and second snap-on connection elements 14/14′ and 13/13. Furthermore, the bridging member 30 may serve to structure adjoined panels by solidifying and locking the rotating hinge joint between the panels. FIG. 9A illustrates two adjoining panels 10, with the bridging member 30 before it is inserted in the raised rib configurations 15. FIG. 9B illustrates the bridging member 30 in place after it has been inserted in the raised rib configurations 15 of the two joined panels 10. As it can be noted on FIG. 9B, the bridging member 30 stabilizes the two panels 10.

The bridging member 30 can also be used to stabilize 4 panels by first assembling two such panels as shown in FIG. 9B, and by then assembling 2 more panels as shown in FIG. 10. Once assembled as such, the bridging member 30 can be moved to the position shown in FIG. 10 where it straddles 4 panels instead of just 2. This will have effect of stabilizing 4 panels.

So as to control the registration and degree of travel of the bridging member 30 once inserted, the inside of each of the “C” shape 100 of the bridging member 30 is further characterized by two rows of ribs 51 which act as abutments against both sides of the perimeter flange/band 11. A gap 60 between the rows of ribs 51 is essentially equal to the thickness of the perimeter flange 11 on panel 10. This insertion of the bridging member 30 can further be made to terminate in a over center snap detail where there is a hole or depression 41 on the panel 10 in the area of the rib configuration 15 and an opposing central rib 52 and 52′ found on the bridging member 30 at the center of each “C”. Each rib 52 and 52′ is the same height as all other ribs 51 and further exhibits a protrusion 38 substantially at the center point of the rib 52/52′, as shown in FIG. 7A, such that when the bridging member 30 is inserted, termination of the insertion includes the snapping of the protrusion 38 into the hole or depression 41. This snap assembly can be made to be removable so as to allow for disassembly.

The rib configuration 15 is found symmetrically on both sides of the perimeter band 11 such that the back to back “C” configuration can be used to pin and hold the panels 10 at a given angle. As shown in FIG. 6A, the bridging member 30 can be fashioned where the openings 54 and 53 can be at various angles one to the other so as to control the various configurations of the inter-panel assembly.

As shown in FIG. 9A and FIG. 9B, the panels 10 are easy to assemble without tools, and may even be assembled by children with limited motor skills. This fact taken into consideration, as well as the fact that bars 17 and 17′ as well as C-shaped members 18 and 18′ must be assembled to each other, by way of a means of compressing the bars 17 and 17′ into the C-shaped members 18 and 18′, the openings 19 and 19′ have been provided to allow the user's finger access to compress the elements together. It should be noted that this assembly procedure may be performed from either side of the panel in an unimpeded fashion. Thus, if the user has assembled multiple panels 10 together, the user may choose to assemble additional panels from the inside or the outside of the constructed assembly.

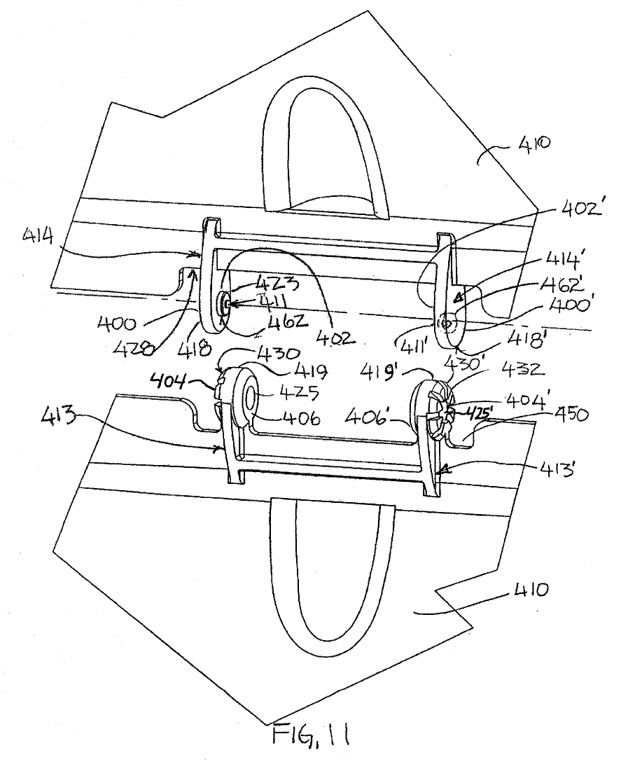

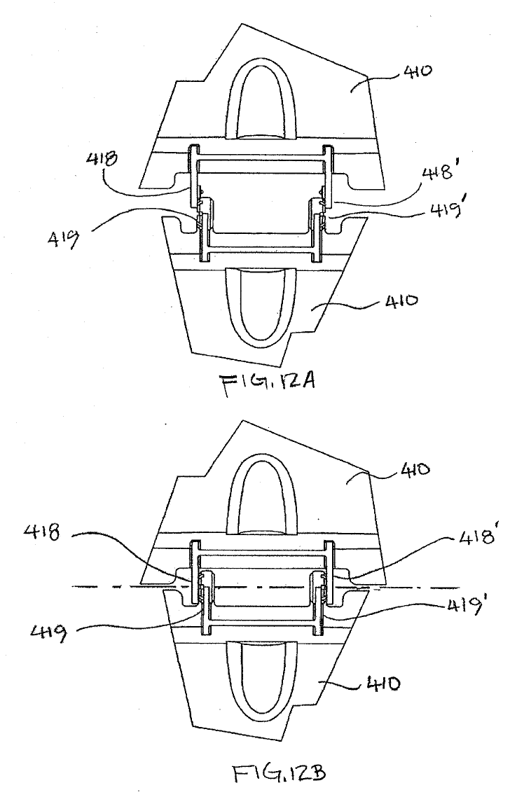

In another illustrative embodiment, the snap-on connection is made by means of a male connecting element and a female connecting element, as will be described in detail hereinbelow, with reference to FIGS. 11, 12A and 12B. Typically, but not necessarily, the connecting elements are located about the center of an edge of a panel, although a longer edge can bear more than one connecting element.

Referring now to FIG. 11, two similar resilient female connecting elements 413 and 413 comprise respectively a flange 419 and a flange 419′ projecting normally from an edge 450 of a first panel 410. The flanges 419 and 419′ are terminated by external surfaces 404 and 404′ and internal surfaces 406 and 406′, each being traversed respectively by center holes 425 and 425′. Opposite to the female connecting elements 413 and 413′, two similar male connecting elements 414 and 414′ comprise respectively a flange 418 and 418′ projecting normally from an edge 428 of another panel 410. Flanges 418 and 418′ are terminated by external surfaces 400 and 400′ and internal surfaces 402 and 402′. Center guide posts 411 and 411′ project respectively from and perpendicular to the internal surfaces 402 and 402′ of male connecting elements 414 and 414′. In a locked position, center guide posts 411 and 411′ are snap inserted respectively in center holes 425 and 425′. It is to be noted that the distance between flanges 418 and 418′ and the distance between flanges 419 and 419′ are chosen so as to provide an effective snap on connection when female connecting elements 413 and 413′ and male connecting elements 414 and 414′ are in the locked position, i.e. the female connecting elements 413 and 413′ and the male connecting element 414 and 414′ are substantially opposite to one another. It is to be noted that, in order to facilitate the snap on connection, i.e. a snap assembly, it is possible to use a material and a thickness so that the male connecting elements 414 and 414′ are also resilient. Indeed, flanges 419 and 419′ may be permitted to elastically deflect when in contact with flanges 418 and 418′, or both pairs of connecting flanges 419 and 419′, and 418 and 418′, may be permitted to deflect elastically and independently when engaged together for snap assembly.

To further facilitate a snap assembly, cylinders 462 and 462′ are interposed between internal surfaces 402 and 402′ on the one hand, and center guide posts 411 and 411′ on the other hand. Cylinders 462 and 462′ each have an outer chamfered edge 423 and 423′, respectively. Chamfers 430 and 430′ are provided on the external surfaces 404 and 404′, wherein chamfers 430 and 430′ interfere with outer chamfered edges 423 and 423′. In a locked position, cylinders 462 and 462′ are coaxially engaged in the center holes 425 and 425′, thus forming a hinge about which the two interlocked panels 410 can pivot. When the cylinders 462 and 462′ are snapped in place in the center holes 425 and 425′, chamfers 430 and 430′ slightly deflect flanges 418 and 418′ outwardly, and flanges 419 and 419′, inwardly, thus allowing cylinders 462 and 462′ to snap in place in the center holes 425 and 425′, as can be seen in FIGS. 12A and 12B.

Yet to further facilitate assembling the connecting elements 413, 413′, 414 and 414′, chamfers 430 and 430′ comprise radial slots 432 for facilitating guiding the center guide posts 411 and 411′ towards the center holes 425 and 425′ and thus engaging the cylinders 462 and 462′ therein. Slots 432 also help prevent center posts 411 and 411′ from being deflected too far from their original positions.

FIG. 12A illustrates the male 414 and 414′ and the female 413 and 413′ connection elements in an unlocked position, just before a locked position is reached, whereas FIG. 12B illustrates the same elements in a locked position.

In the second illustrative embodiment, two panels 410 are being interlocked together about a common axis. However, it is to be noted that more than two panels 410 can be interlocked together about a same axis. Indeed, a panel 410 with male connecting elements having center guiding posts on external surfaces of corresponding flanges, such that the center guiding posts are directed outwardly instead of inwardly, can engage into center holes of a corresponding female connecting element from the inside thereof. In this manner, a panel 410 can be locked by engaging the center holes from the inside, whereas another panel 410 can be locked by engaging the center holes from the outside. As a result, three panels are interlocked together about a same axis. So as to facilitate multiple interlocking of panels, chamfers can be provided on both surfaces, internal and external, of the flanges corresponding to the female connecting elements.

By varying the orientation of, and adding, chamfers and center guiding posts, as well as varying distances between pairs of two male/female connecting elements, it allows three or more panels to be interlocked about a same axis.

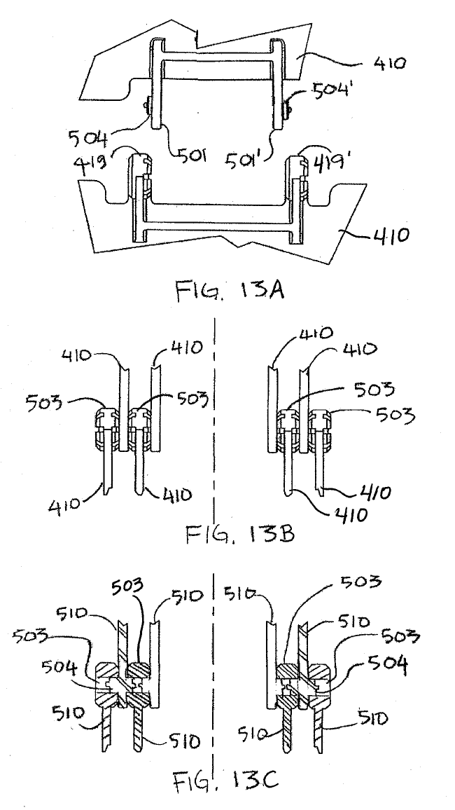

Given by way of examples, FIG. 13A illustrates flanges 419 and 419′ of a female connecting element, and flanges 501 and 501′ of a male connecting element, from which center guiding posts 504 and 504′ protrude outwardly. FIGS. 13B and 13C illustrate an assembly of four panels 410, two of which have female connecting elements with flanges having double chamfer elements 503, the other two panels 410 having male connecting elements with outwardly-directed center guiding posts.

The description of the present invention has been made with illustrative embodiments featuring panels that have a square shape. The illustrative embodiments have been given by way of example and it is to be noted that other shapes for the panels can be used. Indeed, a panel can be of any shape having three sides or more, the length of which can be variable relative to one another. This allows for fabricating structures based on principles of geodesic domes and related geometries, as well as, but not limited to, other Platonic and Archimedian polyhedra, or any other shapes that can conceivably be made from the system of panels, connectors, and clips described hereinabove.

The connection elements are advantageously made from a material that allows repeated deflections to occur, without permanent deformation thereof. Thickness of the connection elements is chosen so as to obtain similar results.

The area of the panel 10 circumscribed by the perimeter band 11 may be flat, dished, embossed, or otherwise formed. This is more clearly shown in FIG. 2 by the convex surface 12 and square frame 16. This convex surface serves to stiffen and strengthen the panel by increasing its moment of inertia and section modulus, respectively. In order to allow efficient stacking of the panels and to lower weight and cost, the thickness of the panel is normally kept as thin as is consistent with end use and method of manufacture. Stiffness and strength may also be adjusted by using different materials, adding or removing ribs, incorporating some other form of surface development, or adding to or subtracting from material thickness.

Although not required for construction of the structures described in this invention, a further part of this invention is the creation of an interactive World Wide Web based tool which allows a builder to build a virtual representation of the structure by selecting from a library of parts and assembling them on a computer.

In its simplest embodiment, this tool allows the builder to construct virtual space enclosures and other structures prior to selecting the pieces required to build them, and to print construction plans for their creation.

Additionally, similar software used to allow a user to build structures via interaction on the World Wide Web, may be accessed by other software dissemination means such as a recorded containment means of said software which the user can then load onto a local computer for use, such as but not limited to an optically recorded digital memory disc.

Furthermore, there is provided a packing box which acts as both a reusable storage box as well as transport dolly, and is adapted to the size and shape of the panels and connectors, and ergonomically suited to the end user's age, strength, and degree of manual dexterity. The box is resealable and can be comprised of wheels to facilitate transport and a handle to securely grip to transport it.

The panels 10 are stackable in a tight arrangement, including in the illustrated embodiment, a relative rotation of 90° between adjacent panels such that there is a substantial nesting of the bars 17/17′ and the C-shaped members 18/18′ of one panel 10 respectively with the C-shaped members 18/18′ and the bars 17/17′ of each of the panel 10 located under and above the aforementioned one panel 10.

Although the present invention has been described hereinabove by way of non-restrictive, illustrative embodiments thereof, these embodiments can be modified at will, within the scope of the appended claims, without departing from the spirit and nature of the subject invention.

1. A system for forming 3-dimensional structures of a variety of shapes, comprising at least two interlocking panels, connectors being provided for attaching together edges of adjacent panels, each said connector comprising first and second connecting elements provided on one and the other of a pair of panels, said first and second connecting elements being adapted to snap engage together for attaching said pair of panels together in an interlocked position of said panels, wherein in said interlocked position, said first and second connecting elements are adapted to allow said pair of panels to pivot relative to one another in said interlocked position.

2. The system as defined in claim 1, wherein bridging members are provided, wherein each panel has at least one first or second connecting element on each of the edges thereof, wherein the panels in said interlocked position are able to swivel about a longitudinal axis of the connector to permit orienting the panels to a selected relative angle therebetween, and wherein adjacent parts of the panels may be fixed in place by one or more bridging member inserted along adjoining edges thereof to substantially prevent a rotation of the connectors.

3-11. (canceled)

12. The system as defined in claim 2, wherein guides are incorporated on the panels to align bridging members in order to locate them on the panels and maintain alignment.

13. (canceled)

14. The system as defined in claim 2, wherein openings are defined in the panel perimeter flange and at said connectors for allowing the panels to be assembled and disassembled either from the outside or the inside of a built structure.

15-21. (canceled)

22. A system for forming 3-dimensional structures of a variety of shapes, comprising interlocking panels, connectors, and locking clips, wherein each panel has at least one connector on at least one of its edges, with said connector being adapted to provide a positive snap-in lock with a mating connector on an adjacent panel, such that the completed connection is able to swivel about a longitudinal axis of the connector to permit orienting the panels to a selected angle in relation to each other, and wherein adjacent parts of the panels may be fixed in place by one or more clips inserted along adjoining edges thereof to substantially prevent a rotation of the connectors.

23-26. (canceled)

27. The system as defined in claim 22, wherein the connectors and the clips or the bridging members incorporate locking mechanisms to ensure that once clipped together they cannot be inadvertently separated under normal use.

28-32. (canceled)

33. The system as defined in claim 22, wherein guides are incorporated on the panels to align the clips or the bridging members in order to locate them on the panels and maintain alignment.

34. (canceled)

35. The system as defined in claim 22, wherein openings are defined in the panel at said connectors for allowing the interlocking panels to be assembled and disassembled either from the outside or the inside of the built structure.

36-42. (canceled)

43. A kit for forming 3-dimensional structures of a variety of shapes, comprising at least two interlocking panels, connectors being provided for attaching together edges of adjacent panels, each said connector comprising first and second connecting elements provided on one and the other of a pair of panels, said first and second connecting elements being adapted to snap engage together for attaching said pair of panels together in an interlocked position of said panels, wherein in said interlocked position, said first and second connecting elements being adapted to allow said pair of panels to pivot relative to one another in said interlocked position.

44. The kit as defined in claim 43, wherein bridging members are provided, wherein each panel has at least one first or second connecting element on each of the edges thereof, wherein the panels in said interlocked position are able to swivel about a longitudinal axis of the connector to permit orienting the panels to a selected relative angle therebetween, and wherein adjacent parts of the panels may be fixed in place by one or more bridging members inserted along adjoining edges thereof to substantially prevent a rotation of the connectors.

45. (canceled)

46. A panel for use with other panels for forming 3-dimensional structures of a variety of shapes, comprising:
at least first and second edges;
a first snap-on connection element about the first edge;
a resilient second snap-on connection element about the second edge, the second snap-on connection element being resilient;
wherein:
the first snap-on connection element of one of said panels is adapted to engage into the resilient second snap-on connection of another of said panels so as to form a snap-on connection interlocking said one panel and said another panel;
the snap-on connection enables a pivotal movement, about an axis, of said panel relative to said another panel.

47. A panel as defined in claim 46, wherein a first opening is defined in the generally flat portion about the first snap-on connection element and a second opening is defined in the generally flat portion about the second snap-on connection element;
wherein the first and second openings enable manual access to respectively the first snap-on connection element and the second snap-on connection element, whereby the first snap-on connection element and the second snap-on connection element can be manually locked and manually unlocked.

48. A panel as defined in claim 46, wherein:
the first snap-on connection element includes a bar;
the second snap-on connection element includes a C-shaped member; and
in a locked position, the C-shaped member snaps on the bar so that that the axis of the C-shaped member is coaxial with the axis of the bar.

49. A panel as defined in claim 48, wherein the C-shaped member further comprises a finger tab.

50. A panel as defined in claim 46, wherein:
the first snap-on connection element is a male connecting member;
the second snap-on connection element is a female connecting member; and
in a locked position, the male connecting member snaps in the female connecting member;
and wherein:
the male connecting element comprises two flanges, each flange having an internal surface and a center post projecting normally from the internal surface; and
the female connecting element comprises two flanges, each flange having a center hole formed therein;
whereby in a locked position, the center posts of one panel engages respectively in the center holes of another panel.

51-53. (canceled)

54. A panel as defined in claim 46, wherein:
the panel comprises a raised rib configuration about the intersection of two edges of the panel, the panel being in combination with a bridging member adapted to engage the raised rib configurations of a pair of adjacent panels for attaching the same thereat.

55. (canceled)

56. A panel as defined in claim 54, wherein said bridging member includes a pair of opposed C-shaped members each adapted to receive therein part of one of the adjacent panels.

57. A panel as defined in claim 56, wherein said C-shaped members include inner ribs for frictionally engaging the parts of the panels located therein.

58. A panel as defined in claim 57, wherein at least one of the inner ribs is adapted to engage an aperture defined in the part of the panel.

59. A panel as defined in claim 56, wherein said C-shaped members include end hook elements adapted to engage the panels, and wherein each said hook element is adapted to engage a groove defined by a pairs of ribs provided on the panel.

60-70. (canceled)
